(19) United States
(12) Patent Application Publication
(10) Pub. No.: US 2004/0193721 A1
(43) Pub. Date: Sep. 30, 2004

(54) Information provider/user system and computer product

(75) Inventors: Kuniharu Takayama, Kawasaki (JP); Yoshiharu Maeda, Kawasaki (JP); Hirohisa Naito, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/820,819

(22) Filed: Apr. 9, 2004

Related U.S. Application Data
(63) Continuation-in-part of application No. PCT/JP01/10143, filed on Nov. 20, 2001.

(51) Int. Cl. G06F 15/16; G06F 12/14; H04L 9/32; G06F 11/30; H04L 9/00

(52) U.S. Cl. 709/229; 713/200

(57) ABSTRACT

An information provider computer program includes computer executable instructions which when executed by a computer, cause the computer to perform obtaining from an information user device permission for providing information to the information user device, receiving permission information corresponding to the permission and to a permission level related to usability of the information to a user, the permission information being issued by the information user device, and transmitting the information and the permission information received to the information user device.

### CROSS-REFERENCE TO RELATED APPLICATIONS

This application is a continuation-in-part of international application no. PCT/JP01/10143, with an international filing date of Nov. 20, 2001, designating the United States. Priority of the above-mentioned application is claimed and the above-mentioned application is hereby incorporated by reference in its entirety.

### BACKGROUND OF THE INVENTION

1) Field of the Invention

The present invention relates to a technology for providing and using information through electronic mails.

2) Description of the Related Art

The Internet has been gaining rapid acceptance and has become an integral part of various aspects of life in recent years. One of the most common aspects is allowing people to provide and use information electronically, typically through electronic mails. On one hand, the electronic mails have the advantage in that by merely specifying an electronic mail address, information can be sent to any user irrespective of time, content, or quality. On the other hand, the electronic mails have the disadvantage in that the user may be deluged with unwanted information through spam mails. Therefore, the requirement for effective means and methods to address this problem has been strongly felt.

FIG. 21 is a block diagram of a first example of a conventional information provider/user system. An information provider device 10, provided at an information provider end, is configured to provide information through electronic mails to an information user via a network 20. The information provider device 10 includes a communication unit 11 configured to control, in accordance with a predetermined communication protocol, communications carried out via the network 20. The information provider device 10 also includes an input unit 12 such as a keyboard and/or a mouse, and an output unit 13 such as a display and/or a printer.

An information provider control unit 14 generates information such as product sale information for the information user, and provides this information to an information user device 30 through an electronic mail. A storage unit 15 stores information such as the information to be transmitted, and electronic mail addresses to which the information is transmitted.

The information user device 30, provided at the information user end, receives via the network 20 the information and allows the information user to browse the information. The information user device 30 includes a communication unit 31 that controls, in accordance with a predetermined communication protocol, communications carried out via the network 20.

The information user device 30 also includes an input unit 32 such as a keyboard and/or a mouse, and an output unit 33 such as a display and/or a printer. An information user control unit 34 controls processes such as reception and display of the information. A storage unit 35 stores various information used by the information user control unit 34.

In FIG. 21, the system in which only one information provider device 10 and one information user device 30 are connected to the network 20 is illustrated. However, in actual information provider/user systems, a plurality of information provider devices 10 and information user devices 30 are connected to the network 20.

When the information provider transmits the information to the information user, the information provider control unit 14 of the information provider device 10 transmits the information to the electronic mail address of the information user. The information user device 30 receives this information via the network 20.

The information user device 30 may also receive information from other information providers. The information user device 30 may thus receive the information one after another from the plurality of information providers.

The information user control unit 34 of the information user device 30 displays a list of the information received on the output unit 33 so that the information user can browse any of the information desired.

In the information provider/user system illustrated in FIG. 21, all kinds of information are transmitted from the information providers to the information user regardless of the user's interests and liking. Therefore, the information user is forced to keep on receiving unwanted information as spam mails. Consequently, the user is also forced to pay extra communication fees for the spam mails and computer resources are wasted on the spam mails.

To solve these problems, an opt-in-mail type information provider/user systems in which information is transmitted only to an information user after the information user has given permission to, receive the information.

FIG. 22 is a block diagram of a second example of a conventional information provider/user system of the opt-in-mail type. Structural units in FIG. 22 that correspond to those in FIG. 21 are assigned with the same reference numerals and redundant descriptions of them are omitted.

In FIG. 22, an information provider device 40, provided at an information provider end, transmits via a network 20 information through electronic mails to an information user who has permitted to receive the information.

An information provider control unit 41 of the information provider device 40 generates information such as product sale information for the information user, and provides the information to an information user device 50 through an electronic mail. The information provider control unit 41 transmits the information only to the pre-registered electronic mail addresses. These electronic mail addresses are provided by those information users who permit to receive the information.

A storage unit 42 stores information such as the information to be transmitted to the information user and the electronic mail addresses that have been provided by the information users who have permitted to receive the information. A registering unit 43 registers the electronic mail addresses into the storage unit 42.

An information user device 50, provided at the information user end, receives via the network 20 the information and allows the information user to browse the information. An application unit 51 of the information user device 50 applies, based on instructions provided by the information user, for the electronic mail address to be registered, to the information provider device 40.

When the information user wants to receive useful information, the information user control unit 34 accesses via the network 20 the information provider device 40 corresponding to the useful information. Next, the application unit 51 applies, based on the instructions provided by the information user, the electronic mail address to be registered, to the information provider 40. The registering unit 43 then registers the electronic mail address into the storage unit 42.

The information provider control unit 41 of the information provider device 40 sends the information to the electronic mail address registered in the storage unit 42. The useful information is received via the network 20 by the information user device 50 and is made use of by the information user. The information is not sent to any electronic mail addresses which are not registered in the storage unit 42 of the information provider device 40.

However, not all information providers use the opt-in-mail type information provider device 40 shown in FIG. 22, as some continue to use the information provider device 10 shown in FIG. 21. Therefore the problems of spam continue to exist.

An information user device may be provided with a unit for distinguishing electronic mail addresses so as to reject reception of information transmitted from a particular electronic mail address (information provider) and not required by the information user. However, this fails to avoid the reception of spam mails from vile information providers if these providers frequently change their electronic mail addresses.

As the communications between the information provider and the information user remains strictly one-sided, i.e., from the information provider to the information user, there is no conventional means by which the information provider may know what kind of information has been of interest to an information user.

Consequently, it is hard to build a trustworthy relationship between the information provider and the information user, and provide and make use of truly useful information with the conventional systems.

### SUMMARY OF THE INVENTION

It is an object of the present invention to solve at least the problems in the conventional technology.

An information provider computer program according to an aspect of the present invention includes computer executable instructions which when executed by a computer, cause the computer to perform obtaining from an information user device permission for providing information to the information user device; receiving permission information corresponding to the permission and to a permission level related to usability of the information to a user, the permission information being issued by the information user device; and transmitting the information and the permission information received to the information user device.

An information user computer program according to another aspect of the present invention includes computer executable instructions which when executed by a computer, cause the computer to perform issuing to an information provider device permission information corresponding to permission for the information provider device to provide information and to a permission level related to a usability of the information to a user; and permitting to receive the information transmitted based on the permission information transmitted with the information from the information provider device. 9. An information provider/user system according to still another aspect of the present invention includes an information provider device and an information user device. The information device includes a permission application unit that applies to an information user device for permission to provide information to the information user device; a permission information receiver that receives permission information corresponding to the permission and a permission level related to a usability of the information to a user, the permission information being issued by the information user device; and a transmitter that transmits the information and the permission information received to the information user device. The information user device includes a permission information issuing unit that issues the permission information to the information provider device; and a reception permission unit that permits the information user device to receive the information based on the permission information transmitted with the information from the information provider device.

The other objects, features, and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a block diagram of a structure according to an embodiment of the present invention;

FIG. 2 is an illustration of a structure of a user information database 110 shown in FIG. 1;

FIG. 3 is an illustration of a structure of a permission level-wise privilege information database 120 shown in FIG. 1;

FIG. 4 is an illustration of a structure of a provider information database 320 shown in FIG. 1;

FIG. 5 is an illustration of a structure of a permission level-wise process information database 330 shown in FIG. 4;

FIG. 6 is an illustration of a structure of a usage status information database 340 shown in FIG. 1;

FIG. 7 is an illustration of a structure of permission information 400 in the embodiment and another embodiment;

FIG. 8 is a flow chart of operations of an information provider device 100 shown in FIG. 1;

FIG. 9 is a flow chart of a permission application process shown in FIG. 8;

FIG. 10 is a flow chart of a permission information receiving process shown in FIG. 8;

FIG. 11 is a flow chart of an information provider process shown in FIG. 8;

FIG. 12 is a flow chart of a privilege providing process shown in FIG. 8;

FIG. 13 is a flow chart of operations of an information user device 300 shown in FIG. 1;

FIG. 14 is a flow chart of a permission process shown in FIG. 13;

FIG. 15 is a flow chart of a permission verification process shown in FIG. 13;

FIG. 16 is a flow chart of an information usage process shown in FIG. 15;

FIG. 17 is a flow chart of a rejection process shown in FIG. 15;

FIG. 18 is a flow chart of a browsing/evaluation process shown in FIG. 13;

FIG. 19 is a block diagram of a structure according to the latter embodiment;

FIG. 20 is a block diagram of a modified structure of the embodiments;

FIG. 21 is a block diagram of an example of a conventional information provider/user system; and

FIG. 22 is a block diagram of another example of a conventional information provider/user system.

### DETAILED DESCRIPTION

Exemplary embodiments of the present invention are explained in detail below with reference to the accompanying drawings.

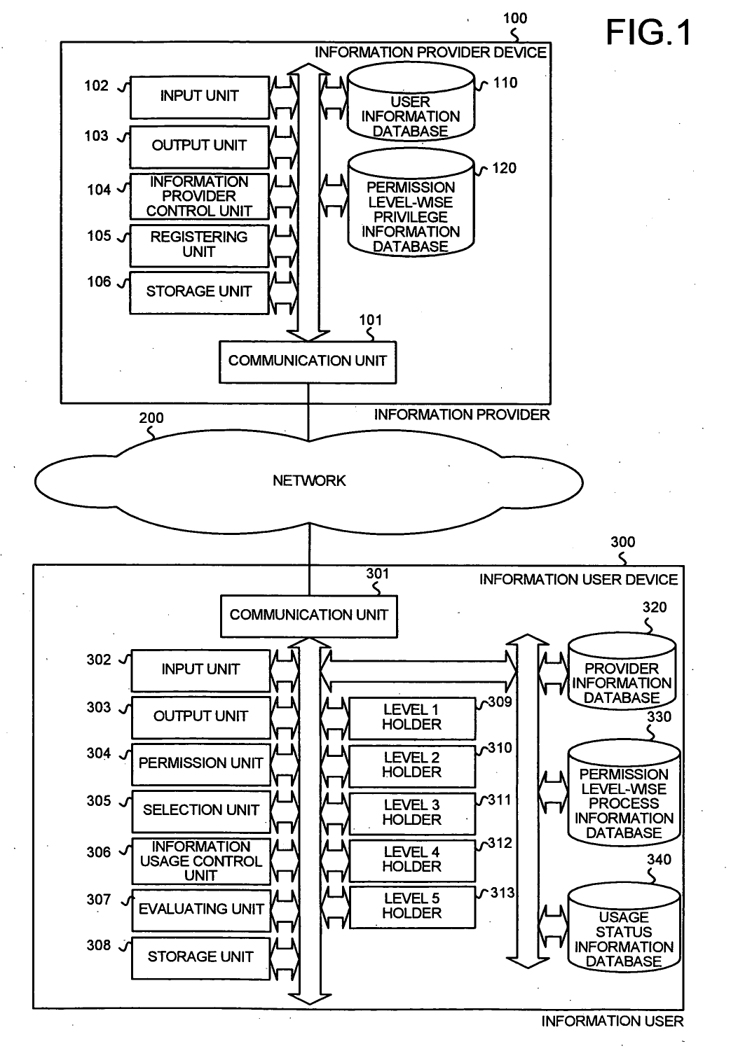

FIG. 1 is a block diagram of an embodiment of the present invention. An information provider device 100, provided at an information provider end, provides an information user via a network 200, permission information and information through means such as electronic mails.

In FIG. 1, one information provider device 100 and one information user device 300 are connected to the network 200. However, in an actual information provider/user system according to the present invention, a plurality of information provider devices 100 and information user devices 300 may be connected to the network 200.

The permission information is information indicating that the information user has permitted to receive the information. The permission information is issued from the information user device 300. FIG. 7 is an illustration of an example of permission information 400. In FIG. 7, a permission number in this permission information 400 is a unique number for identifying the permission information.

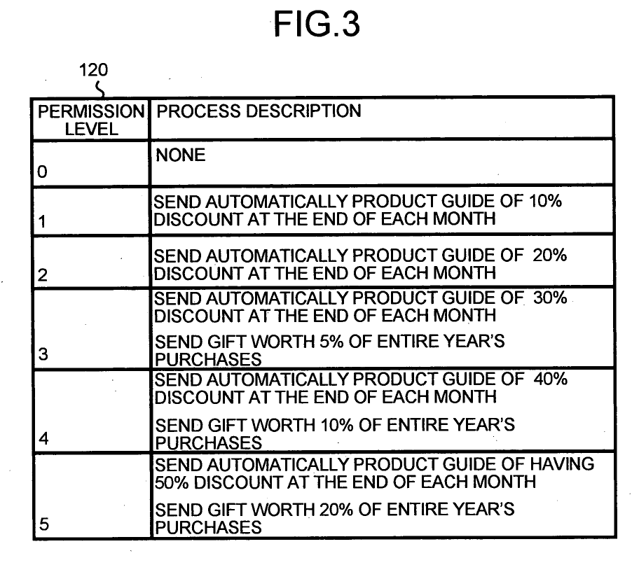

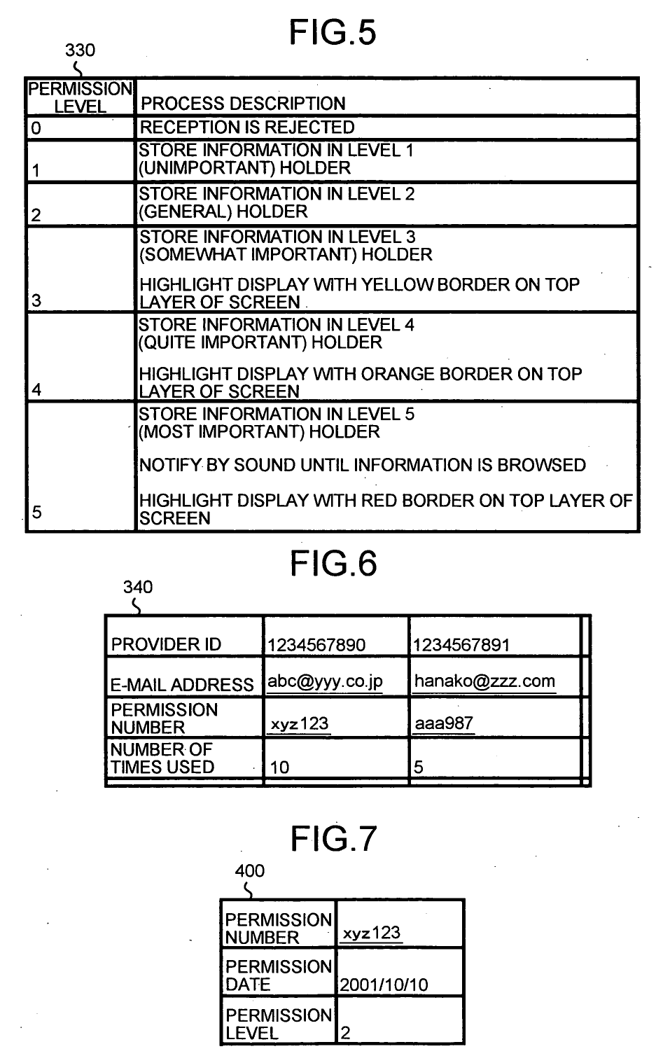

A permission date is a date on which the permission information 400 is issued. Permission level is a level of permission set by the information user and, as illustrated in FIGS. 3 and 5, there are six permission levels of 0 to 5. The permission level indicates how much the information is useful to the information user and hence the higher the permission level is, the more useful the information is to the information user.

A communication unit 101 of the information provider device 100 in FIG. 1 controls, in accordance with a predetermined communication protocol, communications carried out via the network 200. The information provider device 100 also includes an input unit 102, such as a keyboard and/or a mouse, and an output unit 103, such as a display and/or a printer.

An information provider control unit 104 creates information such as product sale information for an information user and sends the information and the permission information to the information user device 300 through an electronic mail. A registering unit 105 registers the permission information from the information user device 300 into a user information database 110. A storage unit 106 stores various information used by the information provider control unit 104.

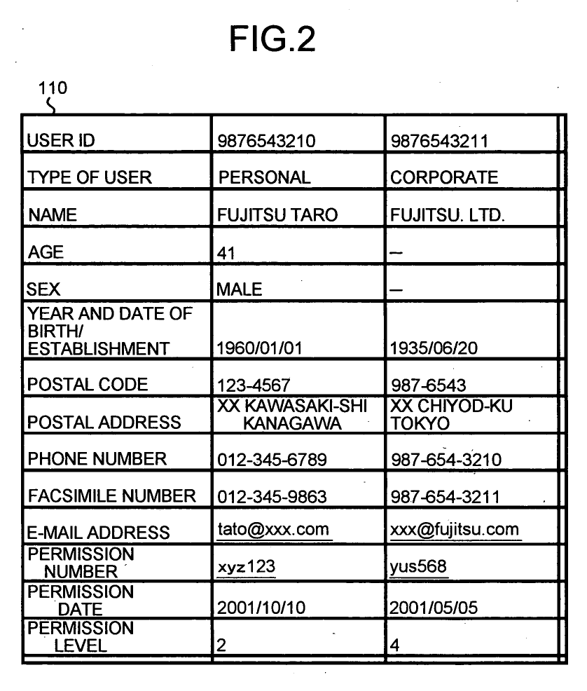

The user information database 110 is a database in which user information related to the information user is stored. This user information includes the permission information. More specifically, the user information database 110 includes fields such as ‘User ID’, ‘Type of User’, ‘Name’, ‘Age’, ‘Sex’, ‘Year and Date of Birth/Establishment’, ‘Postal Code’, ‘Postal Address’, ‘Phone Number’, ‘Facsimile Number’, ‘Electronic Mail Address’, ‘Permission Number’, ‘Date of Permission’, and ‘Permission Level’, as shown in FIG. 2.

The field ‘User ID’ is an identifier for identifying information users. The field ‘Type of User’ refers to a type of the information user (for example, whether the user is a personal user or a corporate user). The field ‘Name’ refers to a name of the personal/corporate user. The field ‘Age’ refers to an age of the user if the user is the personal user. The field ‘Sex’ refers to a gender of the user if the user is the personal user. The field ‘Year and Date of Birth/Establishment’ refers to an year and date of birth of the personal user or a date of establishment of the corporate user. The fields ‘Postal Code’ and ‘Postal Address’ refer to a location of the information user.

The fields ‘Phone Number’ and ‘Facsimile Number’ refer to contact information related to whereabouts of the information user. The field ‘Electronic Mail Address’ refers to an electronic mail address to which information that has been permitted to be received by the information user is transmitted. The fields, ‘Permission Number’, ‘Permission Date’, and ‘Permission Level’ are the permission information described above (see FIG. 7).

In FIG. 1, a permission-level-wise privilege information database 120 stores, in accordance with the permission level, privilege information such as information related to discounts and gifts to be offered to the information user by the information provider at the end of each month or year.

More specifically, the permission level-wise privilege information database 120 includes fields ‘Permission Level’ and ‘Process Description’, as shown in FIG. 3. The field ‘Permission Level’ has six levels from 0 to 5, as shown in FIG. 7. The ‘Process Description’ refers to information related to the privilege offered in accordance with the permission level.

For instance, when the permission level is 0, no process is carried out (that is, no privilege is offered) as the information is of no use to the information user. When the permission level is 1, a product guide of 10% discount is automatically sent to the electronic mail address of the information user at the end of each month. Similarly, when the permission level is 2, a product guide of 20% discount is automatically sent to the electronic mail address of the information user at the end of each month, and so on.

When the permission level is 5, a product guide of 50% discount at the end of each month, as well as a gift worth 20% of an entire year's purchases are sent to the information user at the end of each year. In this way, according to the embodiment, the privilege from the information provider to the information user is stepped up as the permission level goes up.

In FIG. 1, the information user device 300, provided at the information user end, receives via the network 200 the information (permission information) and allows the information user to view the information. The information user device 300 also performs functions of issuing the permission information after the information is permitted to be received, and sending the permission information to the information provider device 100.

A communication unit 301 in the information user device 300 controls, in accordance with a predetermined communication protocol, communications carried out via the network 200. The information user device also includes an input unit 302 such as a keyboard and/or a mouse, and an output unit 33 such as a display and/or a printer and/or speakers. A permission unit 304 gives permission to receive the information and creates the permission information (see FIG. 7). A selecting unit 305 selects, based on presence or absence of the permission information from the information provider device 100 and the permission level, whether the information is to be received or rejected.

An information usage control unit 306 controls various aspects related to usage of the information. An evaluating unit 307 evaluates the usage of the information received or how much the information received is used by the information user, and updates the permission level based on a result of the evaluation. A storage unit 308 stores various information used by the information usage control unit 306.

A level 1 holder 309 stores the information of the permission level 1. A level 2 holder 310 stores the information of the permission level 2. A level 3 holder 311 stores the information of the permission level 3. A level 4 holder 312 stores the information of the permission level 4. A level 5 holder 313 stores the information of the permission level 5.

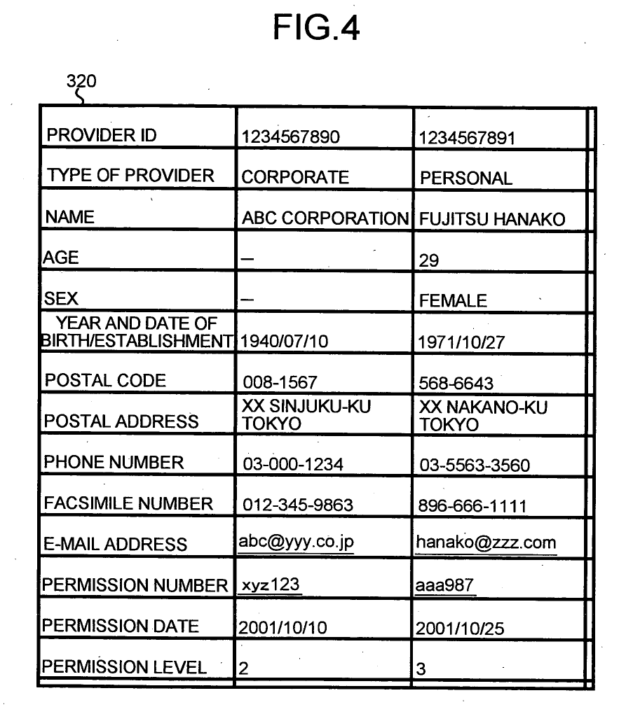

A provider information database 320 stores provider information related to the information provider. More specifically, the provider information database 320 includes fields, ‘Provider ID’, ‘Type of Provider’, ‘Name’, ‘Age’, ‘Sex’, ‘Year and Date of Birth/Establishment’, ‘Postal Code’, ‘Postal Address’, ‘Phone Number’, ‘Facsimile Number’, ‘Electronic Mail Address’, ‘Permission Number’, ‘Permission Date’, ‘Permission Level’, as shown in FIG. 4.

The field ‘Provider ID’ is an identifier for identifying information providers. The field ‘Type of Provider’ refers to a type of the provider (whether the provider is a personal provider or a corporate provider). The field ‘Name’ refers to a name of the personal/corporate provider. The field ‘Age’ refers to an age of the personal provider. The field ‘Sex’ refers to a gender of the personal provider. The field ‘Year and Date of Birth/Establishment’ refers to a year and date of birth of the personal provider or of establishment of the corporate provider. The fields ‘Postal Code’ and ‘Postal Address’ refer to a location of the information provider.

The fields ‘Telephone Number’ and ‘Facsimile Number’ refer to contact information related to whereabouts of the information provider. The field ‘Electronic Mail Address’ refers to the electronic mail address of the information provider, the electronic mail address from which the information to be provided to the information user from the information provider is transmitted. The fields ‘Permission Number’, ‘Permission Date’, and ‘Permission Level’ are the permission information described above (see FIG. 7).

In FIG. 1, a permission level-wise process information database 330 stores information related to process descriptions corresponding to respective permission levels for a process to be carried out when the information is received.

More specifically, the permission level-wise process information database 330 includes fields, ‘Permission Level’ and ‘Process Description’, as shown in FIG. 5. The field ‘Permission Level’ has six levels from 0 to 5, as shown in FIG. 3. The field ‘Process Description’ refers to information related to the process corresponding to the permission level.

For instance, when the permission level is 0, reception of the information is refused. When the permission level is 1, the information received is stored in the level 1 holder 309. Similarly, when the permission level is 2, the information received is stored in the level 2 holder 310.

When the permission level is 3, the information received is stored in the level 3 holder 311. This information corresponding to the permission level 3 is displayed highlighted with a yellow border on a top layer of a screen when the information user browses the information.

When the permission level is 4, the information received is stored in the level 4 holder 312. This information corresponding to the permission level 4 is displayed highlighted with an orange border on the top layer of the screen when the information user browses the information.

When the permission level is 5, the information received is stored in the level 5 holder 313 and its arrival is notified to the information user by a sound until the information is browsed. This information corresponding to the permission level 5 is displayed highlighted with a red border on the top layer of the screen when the information user browses the information.

In FIG. 1, a usage status information database 340 stores usage status information related to usage of the information received by the information user device 300. The evaluating unit 307 uses this usage status information when carrying out evaluation.

More specifically, the usage status information database 340 includes fields such as ‘Provider ID’, ‘Electronic Mail Address’, ‘Permission Number’, and ‘Number of Times Used’, as shown in FIG. 6.

The fields, ‘Provider ID, ‘Electronic Mail Address’, and ‘Permission Number’ correspond to the fields ‘Provider ID, ‘Electronic Mail Address’, and ‘Permission Number’ shown in FIG. 4. The field ‘Number of Times Used’ refers to information related to a number of times the permitted and received information has been used or viewed.

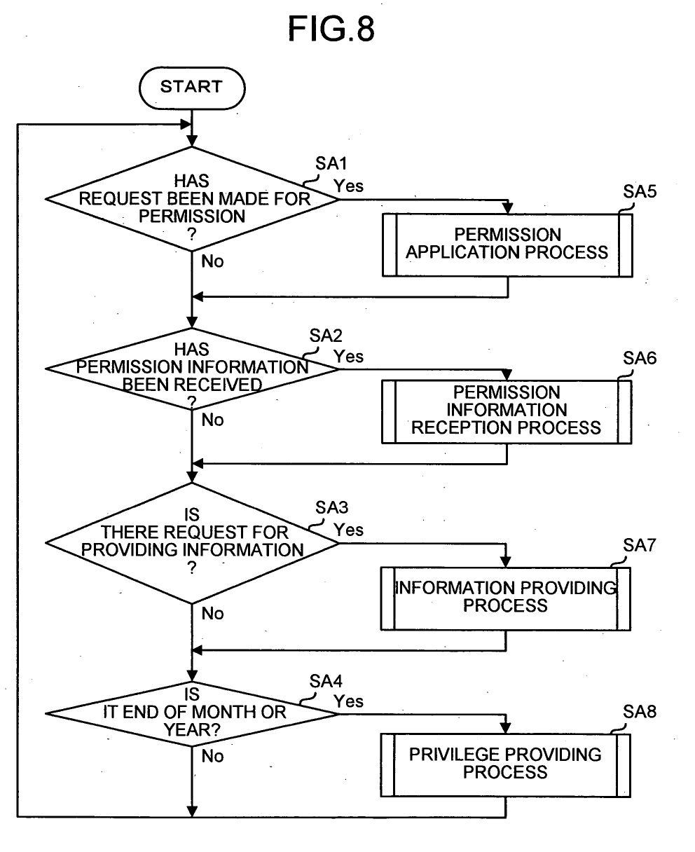

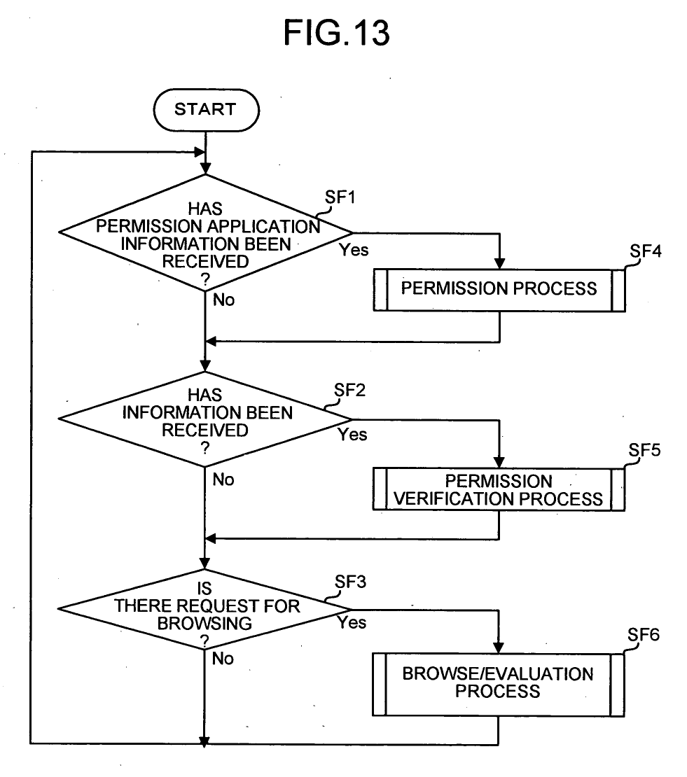

The processes involved in the embodiment will be explained next with reference to the flow charts shown in FIG. 8 through FIG. 18. FIG. 8 is a flow chart of the processes carried out by the information provider device 100 shown in FIG. 1. FIG. 13 is a flow chart of the processes carried out by the information user device 300 shown in FIG. 1.

At step SA1 in FIG. 8, the information provider control unit 104 of the information provider device 100 determines whether a request for permission has been made based on an instruction by the information provider. If a result of the determination is ‘No’, the request for permission is a request for a permission given to the information provider by the information user, the permission related to reception of the information transmitted by the information provider. The information provider makes the request to the information user using permission application information. The permission application information includes contents of the fields from ‘Provider ID’ to ‘Electronic Mail address’ shown in FIG. 4.

At step SA2, the information provider control unit 104 determines whether the permission information has been received from the information user device (for instance, the information user device 300) as a response to the request for permission.

If a result of the determination at step SA2 is ‘No’, the information provider control unit 104 determines at step SA3 whether there is a request for providing information based on an instruction by the information provider. The request for providing information relates to provision of the information to the information user.

If a result of the determination is ‘No at step SA3, at step SA4, the information provider control unit 104 determines whether or not it is currently the end of the month or year. If a result of the determination is ‘No’ at step SA4, the information provider control unit 104 repeats steps SA1 through SA4.

As shown in FIG. 13, at step SF1, the information usage control unit 306 of the information user device 300 determines whether the permission application information has been received via the network 200. If a result of the determination is ‘No’ at step SF1, at step SF2, the information usage control unit 306 determines whether the information has been received via the network 200.

If a result of the determination is ‘No’ at step SF2, at step SF3, the information usage control unit 306 determines whether there is a request to view the information based on an instruction by the information user. If a result of the determination is ‘No’ at step SF3, the information usage control unit 306 repeats steps SF1 through SF3.

If there is the permission application request based on the instruction by the information provider, a result of the determination made by the information provider control unit 104 of the information provider device 100 is ‘Yes’ at step SA1 in FIG. 8. The information provider control unit 104 proceeds to step SA5 to execute a permission application process.

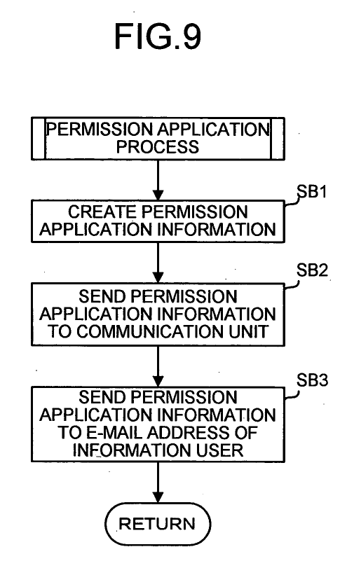

More specifically, the permission application process involves steps shown in the flow chart of FIG. 9. At step SB1, the information provider control unit 104 creates permission application information indicating that a permission to provide the information to the information user corresponding to the information user device 300 is sought. At step SB2, the information provider control unit 104 passes on the permission application information to the communication unit 101. At step SB3, the communication unit 101 sends the permission application information to the electronic mail address of the information user.

When the information user device 300 receives the permission application information, a result of the determination made by the information usage control unit 306 is ‘Yes’ at step SF1 in FIG. 13. In step SF4, a permission process is executed.

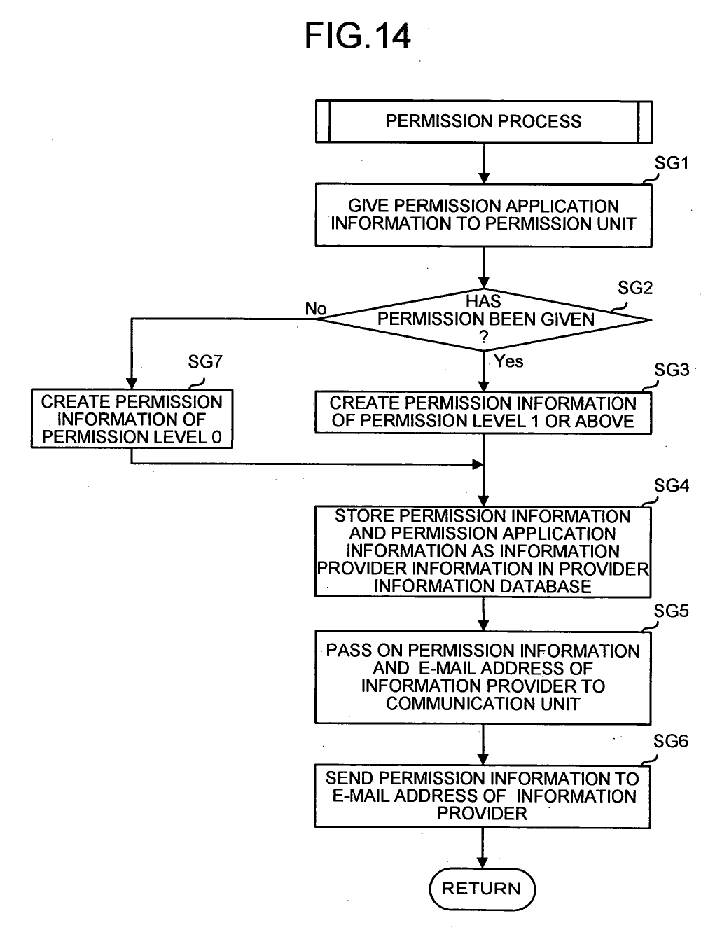

More specifically, the permission process involves steps of the flow chart shown in FIG. 14. At step SG1, the information usage control unit 306 passes on the permission application information to the permission unit 304. At step SG2, the permission unit 304 determines, based on an instruction by the information user, whether to permit to receive the information from the information provider.

If a result of the determination is ‘Yes’ at step SG2, at step SG3, the permission unit 304 creates permission information of permission level 1 or above according an instruction by the information user or as a default setting. In this case, the permission unit 304 creates, based on the instruction of the information user, permission information 400 of permission level 2 as shown in FIG. 7. At step SG4, the information usage control unit 306 stores as information provider information the permission information 400 created at step SG3 and the permission application information into the provider information database 320.

At step SG5, the permission unit 304 passes on the permission information 400 and the electronic mail address of the information provider 400 to the communication unit 301. At step SG6, the communication unit 301 sends the permission information 400 to the electronic mail address of the information provider.

If a result of the determination made at step SG2 is ‘No’, the permission unit 304 creates permission information of level 0 (that is, rejects reception as shown in FIG. 5). Steps SG4 through SG6 are carried out subsequently.

When the permission information 400 is received via the network 200 by the information provider device 100, a result of the determination made by the information provider control unit 104 is ‘Yes’ at step SA2 in FIG. 8. At step SA6, a permission information reception process is executed.

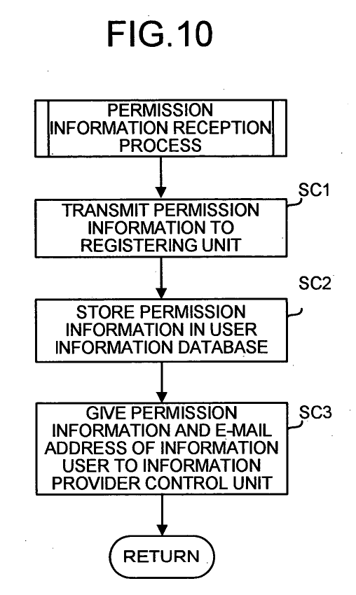

More specifically, the permission information reception process involves steps of the flow chart shown in FIG. 10. At step SC1, the information provider control unit 104 passes on the permission information 400 to the registering unit 105. At step SC2, the registering unit 105 stores the permission information 400 into the user information database 110 shown in FIG. 2. At step SC3, the registering unit 105 passes on the permission information 400 and the electronic mail address of the information user to the information provider control unit 104.

If there is a request for providing information based on the instruction of the information provider, a result of the determination made by the information provider control unit 104 is ‘Yes’ at step SA3 in FIG. 8. At step SA7, an information providing process is executed.

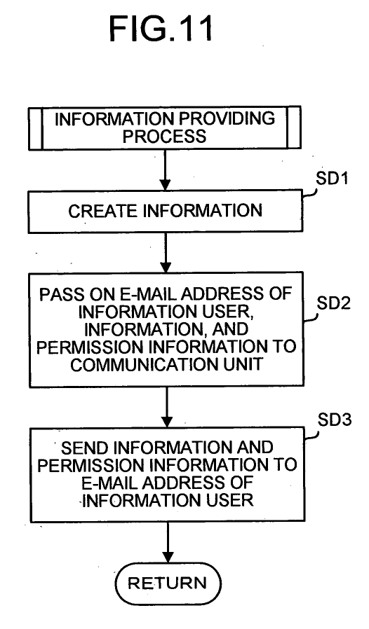

More specifically, the information providing process SA7 involves steps of the flow chart shown in FIG. 11. At step SD1, the information provider control unit 104 creates information to be provided to the information user, based on an instruction by the information provider. At step SD2, the information provider control unit 104 passes on the electronic mail address of the information user stored in the user information database 110, the information to be provided to the information user, and the permission information, to the communication unit 101. At step SD3, the communication unit 101 sends the information and the permission information to the electronic mail address of the information user.

When the information (and the permission information) from the information provider device 100 is received by the information user device 300, a result of the determination made by the information usage control unit 306 is ‘Yes’ at step SF2 in FIG. 13. At step SF5, a permission verification process is carried out.

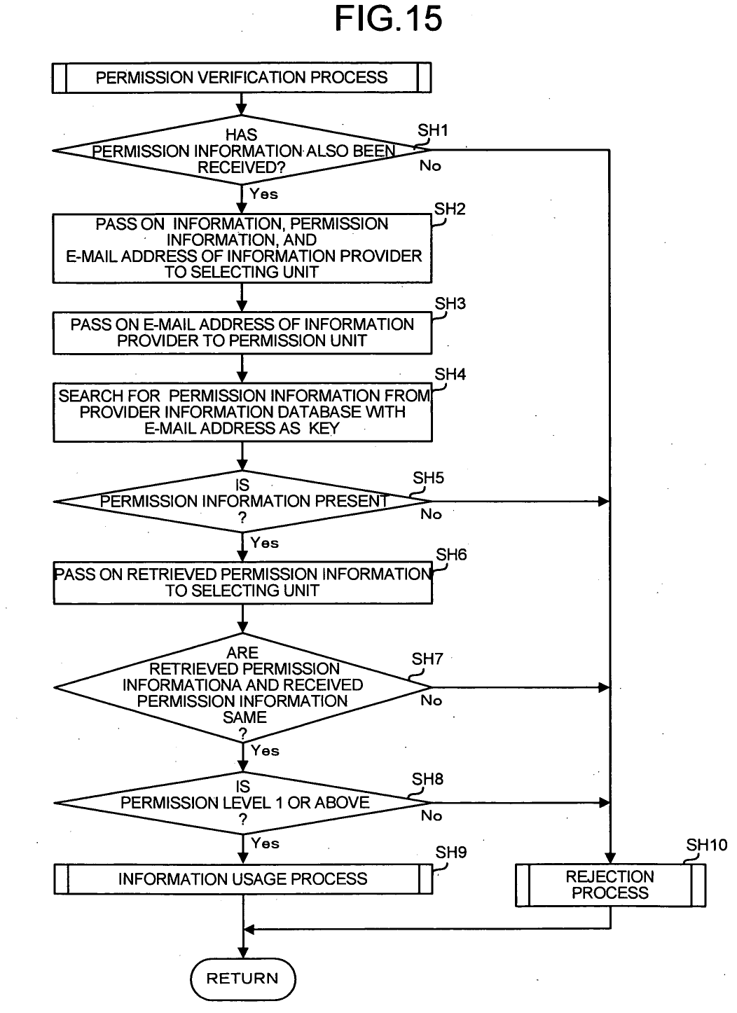

More specifically, the permission verification process involves steps of the flow chart shown in FIG. 15. At step SH1, the information usage control unit 306 determines whether the permission information is also received with the information. If a result of the determination is ‘Yes’ at step SH1, at step SH2, the information usage control unit 306 passes on the information received, the permission information, and electronic mail address of the information provider (sender) to the selecting unit 305.

At step SH3, the selecting unit 305 passes on the electronic mail address to the permission unit 304. At step SH4, the permission unit 304 searches for the permission information (permission number, permission date, and permission level) from the provider information database 320 shown in FIG. 4 with the electronic mail address as a key for the search. At step SH5, the permission unit 304 determines whether the relevant permission information is present as a result of the search.

If a result of the determination is ‘Yes’ at step SH5, at step SH6, the permission unit 304 passes on the permission information retrieved as the result of the search to the selecting unit 305. At step SH7, the selecting unit 305 determines whether the permission information retrieved and the permission information received coincide with each other. If a result of the determination is ‘Yes’ at step SH7, at step SH8, the selecting unit 305 determines whether the permission information received is of level 1 or above.

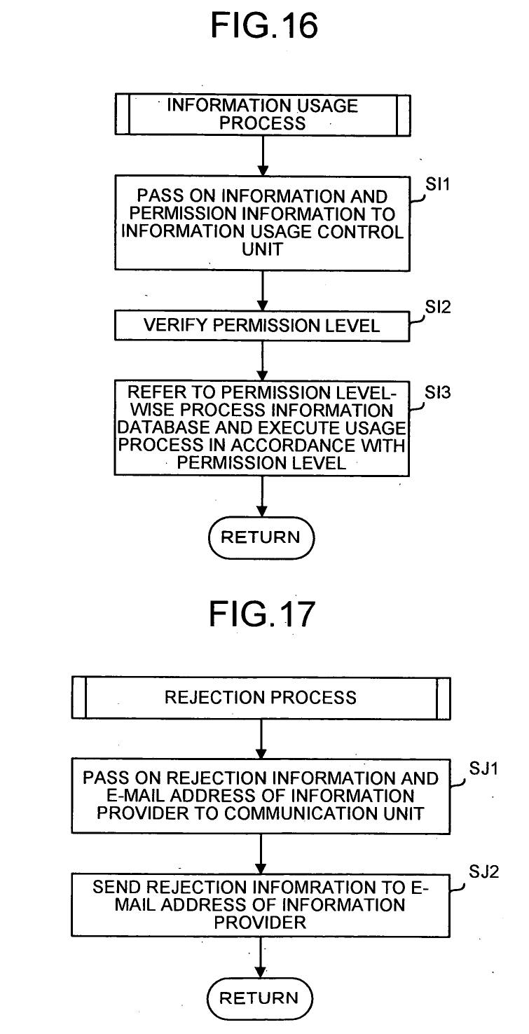

If a result of the determination is ‘Yes’ at step SH8, at step SH9, an information usage process is carried out. More specifically, the information usage process SH9 involves steps of the flow chart shown in FIG. 16. At step SI1, the selecting unit 305 passes on the information and the permission information to the information usage control unit 306.

At step SI2, the information usage control unit 306 identifies the permission level of the permission information. At step SI3, the information usage control unit 306 refers to the permission level-wise process information database 330 shown in FIG. 5 and executes the usage process in accordance with the permission level.

For instance, if the permission level is 2, the information usage control unit 306 stores, according to the ‘Process Description’ in FIG. 5, the information in the level 2 holder 310. If the permission level is 5, the information usage control unit 306 stores the information in the level 5 holder 313 and notifies the information user by a sound from the output unit 303 (speakers) until the information is browsed or viewed by the information user.

If a result of the determination at step SH1 in FIG. 15 is ‘No’ at step SH1, that is, if the information that has not been permitted to be received by the information user (or if the permission information is not transmitted with the information), a rejection process at SH10 is executed.

More specifically, the rejection process involves steps of the flow chart shown in FIG. 17. At step SJ1, a rejection information that indicates that the reception of the information has been rejected and the electronic mail address of the information provider are passed on to the communication unit 301. At step SJ2, the communication unit 301 sends the rejection information to the electronic mail address of the information provider. Upon receiving the rejection information, the information provider deletes the electronic mail address of the information user that has been set as a destination of the information.

The rejection process is also carried out if a result of the determination made at step SH5, SH7, or SH8 in FIG. 15 is ‘No’.

If there is a browse request based on an instruction by the information user for viewing the information stored in the level 1 holder 309 through level 5 holder 313, a result of the determination made by the information usage control unit 306 is ‘Yes’ at step SF3 in FIG. 13. A browse/evaluation process is then carried out at step SF6.

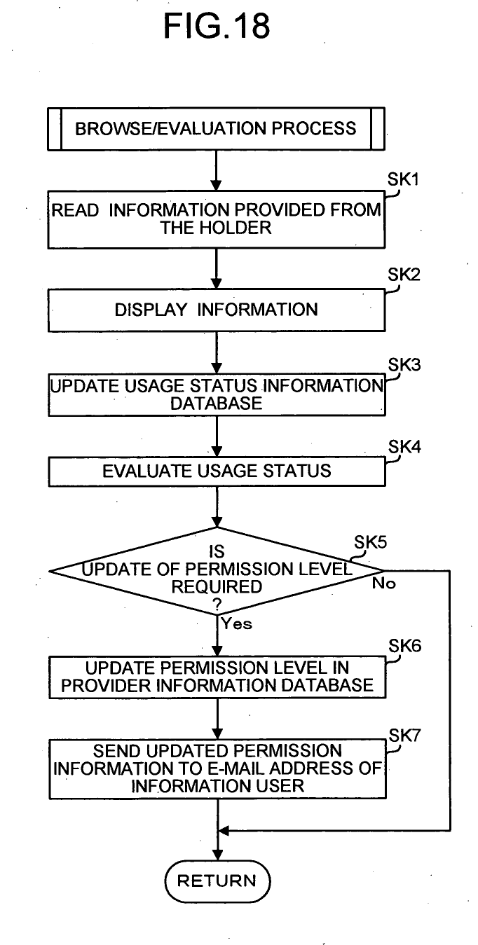

More specifically, the view/evaluation process involves steps in the flow chart shown in FIG. 18. At step SK1, the information usage control unit 306 reads out, based on an instruction by the information user, the relevant information to be browsed, out of level 1 holder 309 to level 5 holder 313.

At step SK2, the information usage control unit 306 identifies the permission level corresponding to the information. For example, the permission level of the information read out from the level 2 holder 310 is 2.

Next, the information usage control unit 306 refers to the permission level-wise process information database 330 shown in FIG. 5, and displays the information, either in a normal manner or highlighted, on the output unit 303. For instance, for the permission levels 1 and 2, the information is displayed in the normal manner. For the permission level 3, the information is displayed highlighted with the yellow border on the top layer of the screen.

At step SK3, the information usage control unit 306 updates the usage status information database 340 shown in FIG. 6. More specifically, the information usage control unit 306 increments by one the ‘Number of Times Used’ field corresponding to the information that has been browsed in the usage status information database 340.

At step SK4, the evaluating unit 307 evaluates the usage status based on the updated ‘Number of Times Used’. More specifically, if the number exceeds a preset threshold value, the evaluating unit 307 determines that the information is frequently used and hence the permission level of the information needs to be updated (increased by one level).

At step SK5, the evaluating unit 307 determines whether it is required to update the permission level. If a result of the determination is ‘Yes’, at step SK6, the evaluating unit 307 updates the permission level in the provider information database 320 shown in FIG. 4. At step SK7, the information usage control unit 306 sends to the electronic mail address of the information user the permission information updated.

When the permission information is received by the information provider device 100, a result of the determination made by the information provider control unit 104 is ‘Yes’ at step SA2 in FIG. 8. Subsequently, as described above, the permission information reception process is carried out and the corresponding permission information in the user information database 110 is updated.

If a result of the determination at step SK5 in FIG. 18 is ‘No’, the current permission level continues to be effective.

At the end of each month or year, a result of the determination made by the information provider control unit 104 of the information provider device 100 is ‘Yes’ at step SA4 in FIG. 8. A privilege providing process is executed at step SA8 in accordance with the permission level.

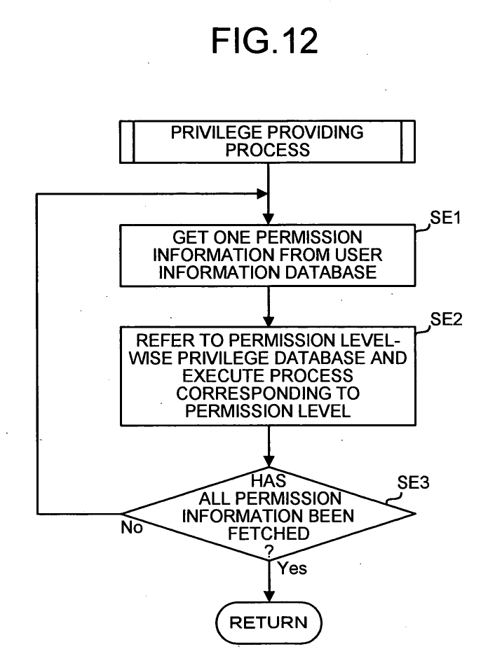

More specifically, the privilege providing process involves steps in the flow chart shown in FIG. 12. At step SE1, the information provider control unit 104 obtains a single permission information (permission number, permission date, and permission level) from the user information database 110 shown in FIG. 2.

At step SE2, the information provider control unit 104 refers to the permission level-wise privilege information database 120 shown in FIG. 3 with the permission level included in the permission information as the key, and executes the process for the privilege corresponding to the permission level. For instance, if the permission level is 2, the information provider control unit 104 automatically sends to the electronic mail address of the relevant information user a product guide of 20% discount by which the information user is given the privilege of 20% discount.

At step SE3, the information provider control unit 104 determines if all the permission information has been fetched from the user information database 110 (see FIG. 2). If a result of the determination is ‘No’, step SE1 onwards are carried out until the result at step SE3 becomes ‘Yes’.

Thus, according to the embodiment, the information provider device 110 receives the permission information (for example the permission information 400 in FIG. 7) issued by the information user device 300 based on the permission application. The permission information indicates that the information provider is permitted to send information to the information user. The permission information also indicates the permission level (see FIG. 5) related to the usefulness or usability of the information to the information user. The information provider device 100 transmits the information to be provided to the information user and the permission information received to the information user device 300. Consequently, by enabling the information user device 300 to grant permission to receive the information based on the permission information, spam mails can be avoided and a good relationship can be maintained between the information provider and the information user.

Further, the information user is given the privileges in accordance with the permission levels shown in FIG. 3. Consequently, the information user can enjoy the benefit in accordance with the usefulness of the information.

Furthermore, the information user can selectively use the information, for which the permission to receive is granted, in accordance with the permission levels shown in FIG. 5. Consequently, the information can be used efficiently in accordance with its usefulness.

Moreover, if the information provider device 100 sends only the information (step SH1: see FIG. 15), reception of the information is refused (step SH10). In this way, spam mails from information providers to which the information user has not applied to for the permission can be avoided.

What is more, if the permission level of the permission information which is sent by the information provider device 100 along with the information is the lowest (step SH8), reception of the information is rejected (step SH10). Thus, spam mails from those information providers to which the information user has already applied to for the permission can be also avoided.

In addition, as explained with reference to FIG. 18, the permission level is updated according to how much the information received has been used. Accordingly, the permission information corresponding to the updated permission level is re-issued to the information provider device 100. As a result, the usefulness of the information from a point of view of the information user can be conveyed in real-time to the information provider.

In the embodiment described above, the permission to receive the information and the transmission of the information are triggered when information provider applies to the information user for the permission to provide the information to the information user. Another embodiment in which the application for the permission, the permission to receive the information, and the transmission of the information are triggered when the information user voluntarily registers the user information to the information provider will be explained below.

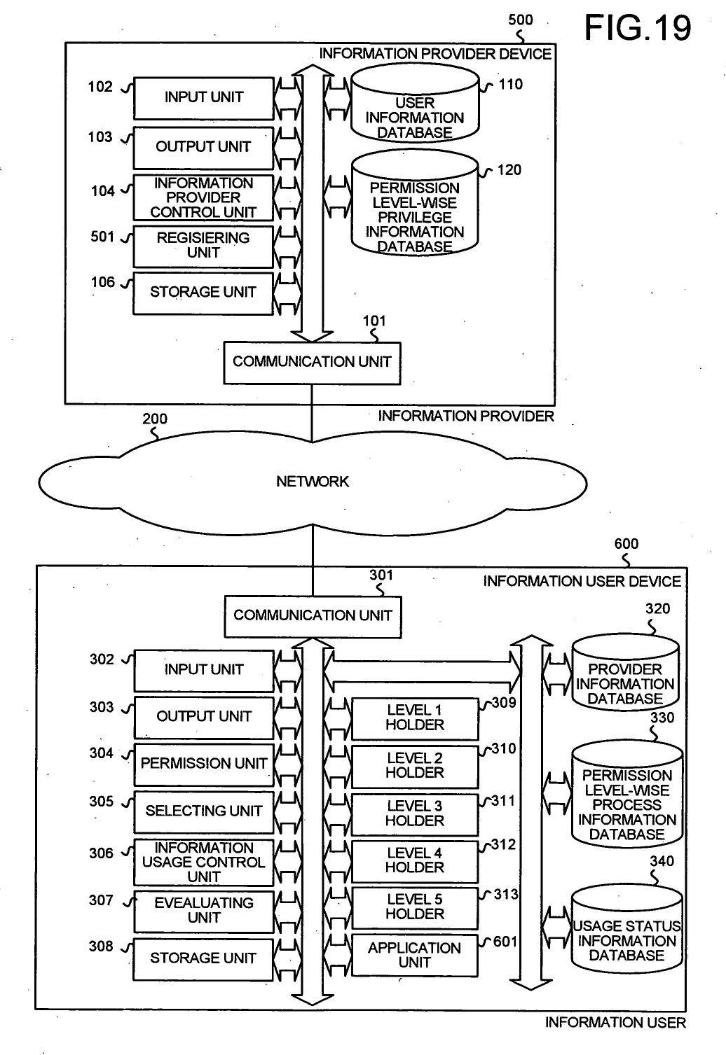

FIG. 19 is a block diagram of a structure according to the another embodiment of the present invention. The structural elements in FIG. 19 that coincide with those in FIG. 1 are assigned with the same reference numerals and descriptions of these elements are thus omitted below.

An information provider device 500, provided at an information provider end, sends via a network 200, permission information and information to an information user through an electronic mail.

In FIG. 19, one each of information provider device 500 and information user device 600 are connected to the network 200. However, in an actual information provider/user system according to the present invention, a plurality of information provider devices 500 and information user devices 600 may be connected to the network 200.

A registering unit 501 of the information provider device 500, registers into a user information database 110 shown in FIG. 2 user information (minus the permission information) voluntarily submitted by the information user.

The information user device 600, provided at the information user end, besides performing the functions of the information user device 300 (see FIG. 1), submits via the network 200, the user information (minus the permission information) voluntarily to the information provider device 500.

An application unit 601 submits, based on an instruction by the information user, ‘User ID’ to ‘Electronic Mail Address’ shown in FIG. 2 as the user information to the information provider device 500.

When information useful to the information user is to be received, the information usage control unit 306 of the information user device 600 accesses via the network 200 the information provider device 500 corresponding to the useful information. The application unit 601 submits, based on an instruction by the information user, the user information (minus the permission information) to the information provider device 500. The registering unit 501 of the information provider device 500 registers the user information (minus the permission information) into the user information database 110 (see FIG. 2).

The sequence of the application for the permission, permission for reception of the information, transmission of the information, and browse/evaluation is carried out based on the user information (minus the permission information) voluntarily submitted by the information user, following the flowcharts of FIGS. 8 to 18, similarly to the previous embodiment.

Therefore, according to the another embodiment, the information provider device 500 receives the user information voluntarily submitted to by the information user device 600. The information provider device then applies to the information user device 600 for the permission to provide the information to the information user based on the user information submitted. Consequently, the information user can initiatively and conveniently obtain the actually desired information.

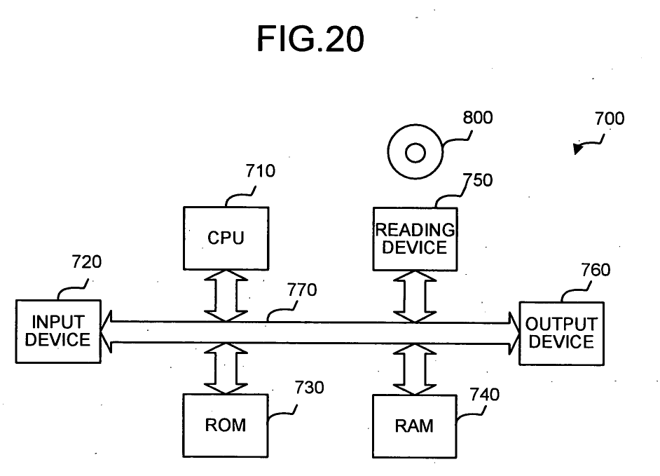

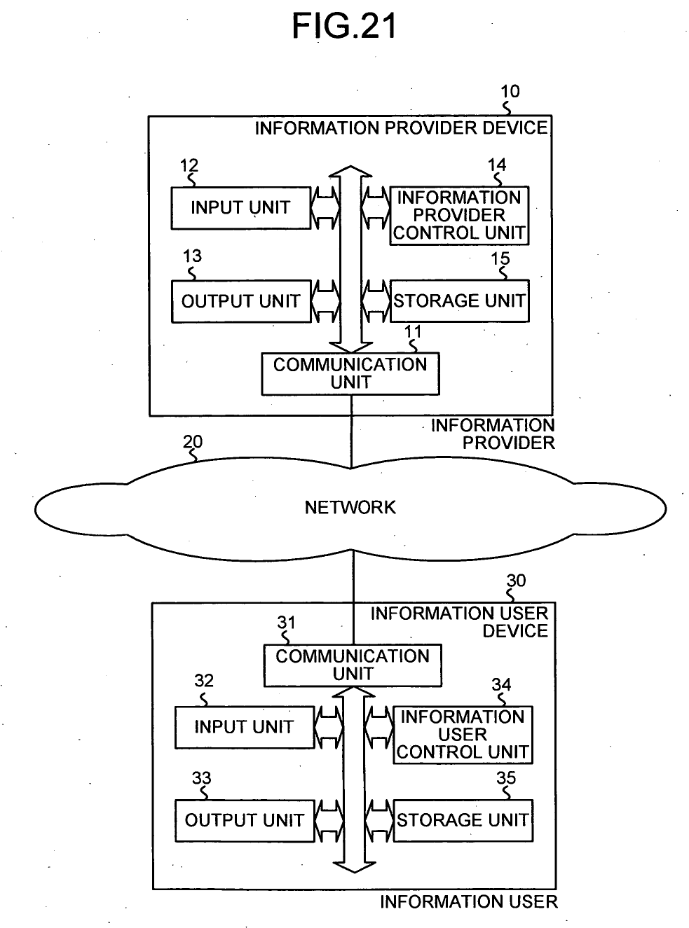

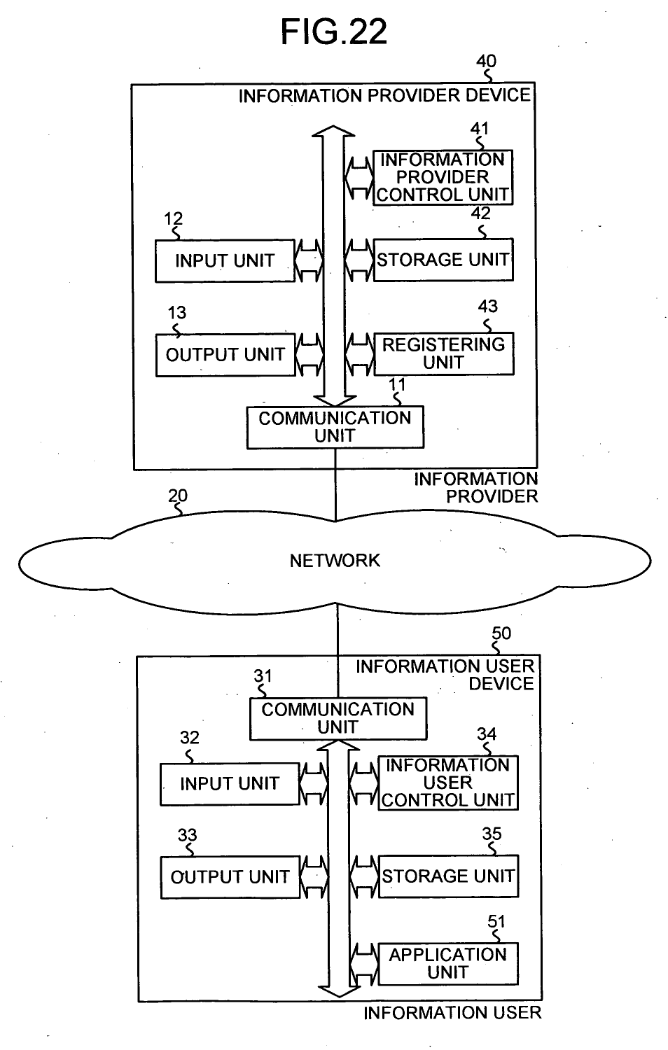

Although these embodiments have been explained with reference to the accompanying drawings, specific examples of structures of the present invention are not limited to the embodiments. All modifications and alternative constructions which fall within the scope of the present invention are included in the present invention. For instance, a computer program for realizing the functions of the information provider device 100 and the information user device 300 shown in FIG. 1, and the information provider device 500 and the information user device 600 shown in FIG. 19 may be recorded on a computer readable recording medium 800 shown in FIG. 20. This computer program may be loaded on a computer 700 shown in FIG. 20 to cause the computer 700 to realize the above functions.

The computer 700 in FIG. 20 includes a CPU 710 that executes the computer program, an input device 720 such as a keyboard and/or a mouse, a read only memory (ROM) 730 for storing various data, a random access memory (RAM) 740 for storing data such as operational parameters, a reading device 750 for reading the computer program from the storage medium 800, an output device 760 such as a display, and/or, a printer, and a bus 770 for connecting all these parts of the computer 700.

The CPU 710 loads via the reading device 750 the computer program stored in the storage medium 800 and executes this computer program, thus realizing the functions described above. The storage medium 800 may be a portable one such as an optical disk, flexible disk, or hard disk.

The information provider computer program, the information user computer program, and the information provider/user system according to the present invention are useful for providing and using information via the network by electronic mails for example.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An information provider computer program including computer executable instructions which when executed by a computer, cause the computer to perform:
obtaining from an information user device permission for providing information to the information user device;
receiving permission information corresponding to the permission and to a permission level related to usability of the information to a user, the permission information being issued by the information user device; and
transmitting the information and the permission information received to the information user device.

2. The information provider computer program according to claim 1, further causing the computer to perform offering a privilege to the user in accordance with the permission level.

3. The information provider computer program according to claim 1, further causing the computer to perform receiving user information voluntarily submitted by the user, wherein the obtaining of the permission for providing the information to the information user device is realized based on the user information.

4. An information user computer program including computer executable instructions which when executed by a computer, cause the computer to perform:
issuing to an information provider device permission information corresponding to permission for the information provider device to provide information and to a permission level related to a usability of the information to a user; and
permitting to receive the information transmitted based on the permission information transmitted with the information from the information provider device.

5. The information user computer program according to claim 4, further causing the computer to perform selectively using the information permitted to be received, in accordance with the permission level of the permission information.

6. The information user computer program according to claim 4, further causing the computer to perform refusing to receive the information transmitted, if only the information is transmitted by the information provider device.

7. The information user computer program according to claim 4, further causing the computer to perform refusing to receive the information transmitted, if the permission level of the permission information transmitted with the information by the information provider device is the lowest.

8. The information user computer program according to claim 4, further causing the computer to perform:
updating the permission level in accordance with how much the information permitted to be received is being used by the information user; and
reissuing to the information provider device new permission information corresponding to the permission level updated.

9. An information provider/user system comprising an information provider device and an information user device,
the information device including
a permission application unit that applies to an information user device for permission to provide information to the information user device;
a permission information receiver that receives permission information corresponding to the permission and a permission level related to a usability of the information to a user, the permission information being issued by the information user device; and
a transmitter that transmits the information and the permission information received to the information user device;
the information user device including
a permission information issuing unit that issues the permission information to the information provider device; and
a reception permission unit that permits the information user device to receive the information based on the permission information transmitted with the information from the information provider device.

10. The information provider/user system according to claim 9, wherein the information provider device further includes a privilege provider that offers a privilege to the user in accordance with the permission level.

11. The information provider/user system according to claim 9, wherein
the information provider device further includes a user information receiver that receives user information voluntarily submitted by the user, and
the permission application unit performs the application based on the user information.

12. The information provider/user system according to claim 9, wherein the information user device further includes a using unit that selectively uses the information permitted to be received, in accordance with the permission level of the permission information.

13. The information provider/user system according to claim 9, wherein the reception permission unit refuses to receive the information transmitted, if only the information is transmitted by the information provider device.

14. The information provider/user system according to claim 9, wherein the reception permission unit refuses to receive the information transmitted, if the permission level of the permission information transmitted with the information by the information provider device is the lowest.

15. The information provider/user system according to claim 9, wherein the information user device further includes a permission level update unit that
updates the permission level in accordance with how much the information permitted to be received is being used by the information user and
reissues to the information provider device new permission information corresponding to the permission level updated.
